(19) United States
(12) Patent Application Publication
(10) Pub. No.: US 2026/0113061 A1
(43) Pub. Date: Apr. 23, 2026

(54) WIRELESS COMMUNICATION DEVICE AND METHOD OF CONTROLLING RECEPTION OF PHYSICAL LAYER PACKET

(71) Applicant: Realtek Semiconductor Corporation, Hsinchu (TW)

(72) Inventors: Shiue-Ru WU, Hsinchu (TW); Ya-Hsueh HUANG, Hsinchu (TW); Chia-Chun HUNG, Hsinchu (TW)

(21) Appl. No.: 19/351,309

(22) Filed: Oct. 7, 2025

(30) Foreign Application Priority Data
Oct. 22, 2024 (TW) 113140180

(51) Int. Cl. H04B 1/00; H04B 1/44; H04L 5/00

(52) U.S. Cl. CPC H04B 1/006; H04B 1/44; H04L 5/0048

(57) ABSTRACT

A wireless communication device includes an MAC circuit, an RF circuit, and a baseband circuit. The MAC circuit is configured to simultaneously join or create networks that work on a first channel and a second channel, respectively. The RF circuit is configured to switch to the first channel according to a control of the MAC circuit. The baseband circuit is configured to stay on the first channel for a first symbol period to perform a preamble detection. If a preamble of a PHY layer packet is detected during the first symbol period, the baseband circuit further stays on the first channel for a second symbol period to continue receiving the preamble, and calculates the correlation between the data received respectively during the first symbol period and the second symbol period, and determines whether to stay on the first channel to continue receiving the PHY layer packet accordingly.

### RELATED APPLICATIONS

This application claims priority to Taiwan Application Serial Number 113140180, filed October 22, 2024, which is herein incorporated by reference.

### BACKGROUND

### Technical Field

The present disclosure relates to manipulation of physical (PHY) layer packet receptions, and more particularly to a wireless communication device and a method of controlling PHY layer packet receptions.

### Description of Related Art

With the development of information and communication technologies, the information and communication industries have developed various wireless communication protocols for various application scenarios and usage requirements, such as the wireless local area network (WLAN), the Bluetooth, the ZigBee, and the Thread communication protocols, in which the WLAN communication protocol is developed based on the PHY layer and the media access control (MAC) layer of the IEEE 802.11 Standards, the Bluetooth communication protocol is developed based on the PHY layer and the MAC layer of the IEEE 802.15.1 Standards, and the ZigBee and the Thread communication protocols are developed based on the PHY layer and the MAC layer of the IEEE 802.15.4 Standards and are commonly used in households or Industrial Internet of Things (IIoT). For hardware of a device supporting the PHY layer and the MAC layer of the IEEE 802.15.4 Standards, various supported communication protocols developed based on the IEEE 802.15.4 Standards may be added by software replacement, and furthermore multiple IEEE 802.15.4-based communication protocols may be executed simultaneously at the device.

On the other hand, according to the IEEE 802.15.4 Standards, a device supporting IEEE 802.15.4 may be a coordinator, a router, or an end device. When a device is used as a coordinator or a router, the radio frequency (RF) circuit thereof shall be always on for capable of receiving a packet from another node device at any time. Therefore, for a device that supports two IEEE 802.15.4-based protocols at the same time, if the device is used as a coordinator or router in both networks (which may work on different channels), it shall be always on in both networks to receive packets at any time.

### SUMMARY

The present disclosure provides a mechanism for controlling reception of PHY layer packets, which can simultaneously join two networks operating in different channels, and can alternately switch to different channels to monitor physical layer packets through time-division multiplexing, and thus the hardware costs is not significantly increased and the time for detecting the preamble in the PHY layer packet is reduced, so as to effectively increase the frequency of monitoring packets in each channel.

The present disclosure provides a wireless communication device which includes an MAC circuit, an RF circuit, and a baseband circuit. The MAC circuit is configured to join or create a first network that works on a first channel and a second network that works on a second channel at the same time. The RF circuit is configured to switch to the first channel according to a control of the MAC circuit. The baseband circuit is coupled to the MAC circuit and the RF circuit, and is configured to stay on the first channel for a first symbol period to perform a preamble detection after the RF circuit completes switching to the first channel. In response to detecting a preamble of a PHY layer packet during the first symbol period, the baseband circuit further stays on the first channel for a second symbol period to continue receiving the preamble, and calculates a correlation between data received respectively during the first symbol period and the second symbol period, and determines whether to stay on the first channel to continue receiving the PHY layer packet based on the correlation.

The present disclosure further provides a method of controlling physical layer packet reception performed by a wireless communication device and including: joining or creating a first network that works on a first channel and a second network that works on a second channel, and switching to the first channel at the same time; staying on the first channel for a first symbol period to perform a preamble detection; and in response to detecting a preamble of a PHY layer packet during the first symbol period, staying on the first channel for a second symbol period to continue receiving the preamble, and calculating a correlation between data received respectively during the first symbol period and the second symbol period, and determining whether to stay on the first channel to continue receiving the PHY layer packet based on the correlation.

### BRIEF DESCRIPTION OF THE DRAWINGS

The foregoing aspects and many of the accompanying advantages of this disclosure will become more readily appreciated as the same becomes better understood by reference to the following detailed description, when taken in conjunction with the accompanying drawings.

FIG. 1 is a schematic electrical block diagram of a wireless communication device in accordance with some embodiments of the present disclosure.

FIG. 2 illustrates a PHY layer packet formant in compliance with the IEEE 802.15.4 Standards.

FIGS. 3A and 3B are various examples of alternately sounding two channels at a receiving end of a wireless communication network supporting the IEEE 802.15.4 Standards.

FIG. 4A is a schematic flowchart of a method of controlling PHY layer packet reception in accordance with some embodiments of the present disclosure.

FIG. 4B is a schematic flowchart of a method of controlling PHY layer packet reception in accordance with other some embodiments of the present disclosure.

### DETAILED DESCRIPTION

The detailed explanation of the disclosure is described as following. The described preferred embodiments are presented for purposes of illustrations and description, and they are not intended to limit the scope of the disclosure.

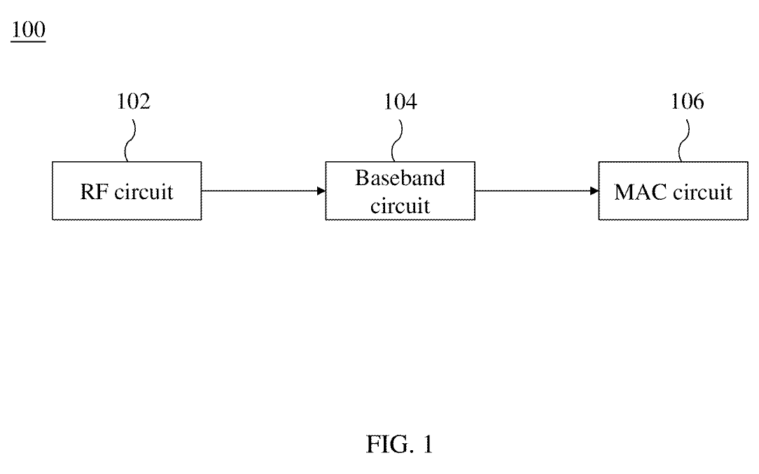

FIG. 1 is a schematic electrical block diagram of a wireless communication device 100 in accordance with some embodiments of the present disclosure. The wireless communication device 100 is used in a low-power wireless personal area network (LP-WPAN) supporting the IEEE 802.15.4 Standards and supports IEEE 802.15.4-based communication protocols, such as ZigBee and/or Thread, but is not limited thereto.

As shown in FIG. 1, the wireless communication device 100 includes an RF circuit 102, a baseband circuit 104, and an MAC circuit 106, in which the RF circuit 102 and the baseband circuit 104 belong to a PHY layer, and the MAC circuit 106 belongs to an MAC layer. The RF circuit 102 is configured to receive a PHY layer packet to generate an RF signal and convert the RF signal into a baseband signal. In the present disclosure, the PHY layer packet transmitted from a device is received by the RF circuit 102 in a form of electromagnetic waves for generating an RF signal, and the RF signal is converted into a baseband signal by a frequency-down converting process of the RF circuit 102. The baseband circuit 104 is coupled to the RF circuit 102 and is configured to decode the baseband signal to obtain bit data. The MAC circuit 106 is coupled to the baseband circuit 104 and is configured to parse the bit data to obtain information of each field in the PHY layer packet received by the wireless communication device 100.

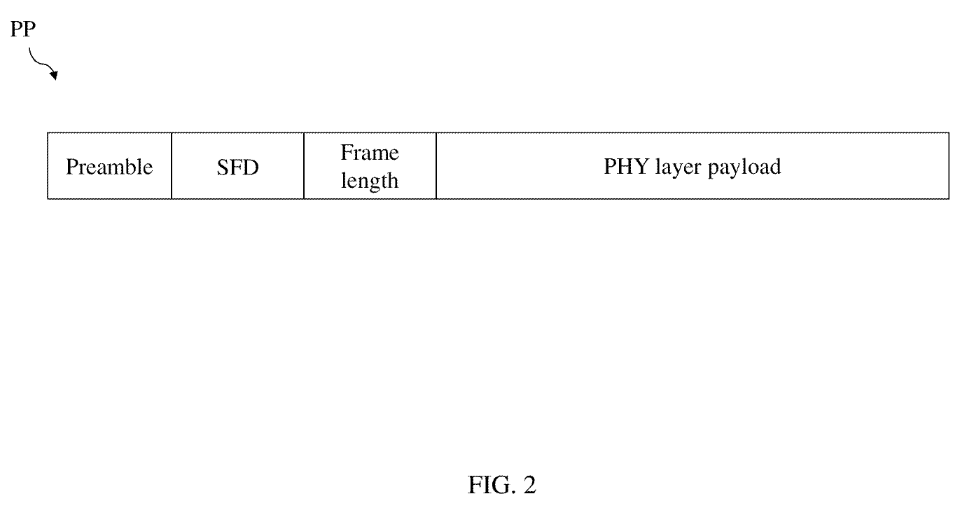

FIG. 2 illustrates a format of a PHY layer packet PP in compliance with the IEEE 802.15.4 Standards, which includes a preamble, a start of frame delimiter (SFD), a frame length, and a PHY payload in sequence. The preamble (or referred to as a preamble field) is composed of 32 bits, which is used for a receiving end to synchronize its clock and detect the start of the packet and the signal energy. The SFD is used to indicate the end of the preamble and the start of the packet data (including the frame length and the PHY layer payload). The frame length is used to indicate the length of the PHY layer payload of the receiving end. The PHY payload is the data from the upper layers (including the application layer to the MAC layer). The condition in which the PHY layer packet PP is successfully received is that the preamble and the SFD can be detected and the symbol demodulation is aligned with the boundary of the preamble.

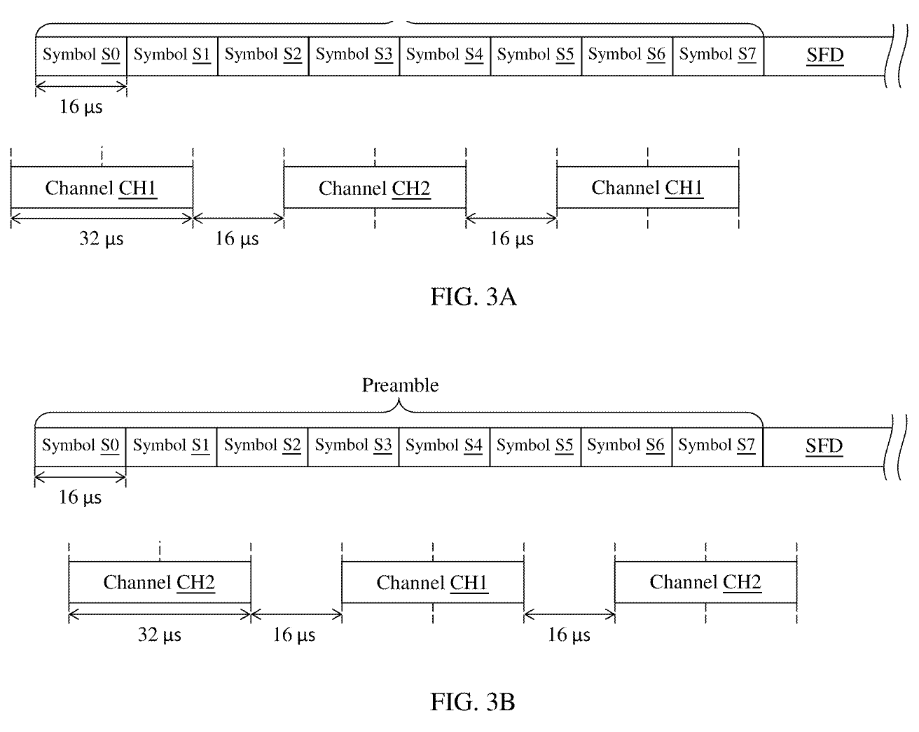

If a coordinator or router supporting the IEEE 802.15.4 Standard in added or created networks working at different channels shall be always on for receiving PHY layer packets at any time, this can be achieved in two ways. One is to use two sets of PHY layer hardware to work on different channels. However, this method significantly increase the hardware cost. The other is to apply a time division technology for PHY layer hardware to sound and receive PHY layer packets at two channels alternately. FIGS. 3A and 3B are various examples of alternately sounding two channels (including channels CH1 and CH2) at a receiving end of a wireless communication network supporting the IEEE 802.15.4 Standards. As shown in FIGS. 3A and 3B, the preamble of the PHY layer packet in compliance with the IEEE 802.15.4 Standards includes 8 consecutive and repeated preamble symbols (sequentially symbols S0-S7), and each preamble symbol is transmitted in a symbol period (i.e., a slot with a time length of 16 μs).

In the wireless communication network, because the transmitting end may start transmitting a PHY layer packet at any time, and the time when the transmitting end starts a transmission is uncorrelated with the time when the receiving end switches the channel, every time when the receiving end switches the channel, the RF circuit of the receiving end has to remain stable (i.e., completion of channel switching) for at least two preamble symbols (i.e., 32 μs), in order to successfully receiving at least one preamble symbol. In a condition in which the duration of each channel is 32 μs, in order to ensure that at least two preamble symbols can be received on the same channel in a time period corresponding to the preamble (i.e., 128 μs) for preamble symbol alignment, the time interval (i.e., the time required for RF circuit of the receiving end to perform channel switching) of the receiving end switches from a channel to another channel (e.g., from the channel CH1 to the channel CH2) is at most 16 μs. In FIG. 3A, the receiving end switches to the channel CH1 before the transmitting end starts transmitting the PHY layer packet and successfully receives the symbol S0 in a duration of the channel CH1, and then after two channel switches, the receiving end successfully receives the symbol S6 in the duration of the channel CH1 and keeps at the channel CH1 to continue receiving the subsequent part of the PHY layer packet including the SFD. Whereas in FIG. 3B, the receiving end switches to the channel CH2 after start of transmitting the PHY layer packet and successfully receives the symbol S1 in a duration of the channel CH2, and then after two channel switches, the receiving end successfully receives the symbol S7 in the duration of the channel CH2 and keeps at the channel CH2 to continue receiving the subsequent part of the PHY layer packet including the SFD.

However, for the wireless communication device, the RF circuit thereof may not complete channel switching in 16 μs due to the factors of hardware design and noise, which results in unable to receive two complete preamble symbols on the same channel in the time period corresponding to the preamble. In such a condition, the wireless communication device cannot receive a PHY layer packet and thus results in a connection error.

Referring back to FIG. 1, in some embodiments of the present disclosure, the wireless communication device 100 may simultaneously join two networks working at different channels, and may be as a coordinator or a router in these networks. In addition, in some embodiments of the present disclosure, the channel switching time of the RF circuit 102 of the wireless communication device 100 does not need to be limited in 16 μs (e.g., can be in 32 μs), in order to avoid the aforementioned connection error due to unable to receive the PHY layer packet. The detailed description of the wireless communication device 100 for detecting a PHY layer packet is as follows. In the beginning, the MAC circuit 106 joins or creates networks (e.g., a ZigBee network and a Thread network of IEEE 802.15.4-based networks) respectively working on a first channel and a second channel at the same time, and controls the RF circuit 102 to switch to one of the channels (the first channel). Then, after the RF circuit 102 completes switching to the first channel, the baseband circuit 104 stays at the first channel for a symbol period (the first symbol period) for preamble detection (which does not need to be aligned with a boundary of a preamble symbol). If the preamble is detected in the symbol period, the baseband circuit 104 stays at the same channel (the first channel) for an additional symbol period (the second symbol period) to continue receiving the preamble of the PHY layer packet and receive the correlation of the data received respectively during these consecutive symbol periods (i.e., the first symbol period and the second symbol period). Otherwise, if the preamble is not detected in the symbol period, the baseband circuit 104 triggers the MAC circuit 106 to control the RF circuit 102 to switch to the other channel (the second channel) for the same operations, i.e., the baseband circuit 104 stays at the second channel for a symbol period for preamble detection; if the preamble is detected in the symbol period, the baseband circuit 104 stays at the same channel (the second channel) for an additional symbol period to continue receiving the preamble of the PHY layer packet and receive the correlation of the data received respectively during these consecutive symbol periods.

The baseband circuit 104 may determine whether to stay on the same channel to continue receiving the PHY layer packet based on the calculated correlation. If the correlation of the data received respectively during two consecutive symbol periods is at least a first threshold, the baseband circuit 104 notifies the MAC circuit 106 to stay at the same channel (the first channel) to continue receiving the preamble and then detect the SFD in the same PHY layer packet. Otherwise, if the correlation of the data received respectively during two consecutive symbol periods is less than the first threshold, the baseband circuit 104 triggers the MAC circuit 106 to control the RF circuit 102 to switch to the other channel (the second channel) for preamble detection. The first threshold may be determined according to, for example, the noise strength of the environment at which the wireless communication device 100 is located. For example, in a high signal-to-noise ratio (SNR) environment, the baseband circuit 104 may set the first threshold higher.

In other embodiments, if the correlation of the data received respectively during two consecutive symbol periods is at least the first threshold when the MAC circuit 106 keeps at the first channel, the baseband circuit 104 notifies the MAC circuit 106 to stay at the same channel (the first channel) to continue receiving the preamble, and to calculate the correlation of the data received during the period between start of receiving the preamble and completion of receiving the preamble and a preset preamble pattern when the preamble is completely received. If the correlation of the data received during the period between the start of receiving the preamble and the completion of receiving the preamble and the preset preamble pattern is at least a second threshold, the baseband circuit 104 notifies the MAC circuit 106 to stay at the same channel (the first channel) to detect an SFD in the same PHY layer packet. Otherwise, if the correlation of the data received during the period between the start of receiving the preamble and the completion of receiving the preamble and the preset preamble pattern is less than the second threshold, the baseband circuit 104 triggers the MAC circuit 106 to control the RF circuit 102 to switch to the other channel (the second channel) for preamble detection. Similarly, the second threshold may be determined according to, for example, the noise strength of the environment at which the wireless communication device 100 is located. For example, in a high SNR environment, the baseband circuit 104 may set the second threshold higher.

If the baseband circuit 104 detects an SFD in a preset detection period, the baseband circuit 104 notifies the MAC circuit 106 to stay at the same channel (the first channel) and receive the PHY layer packet completely, and may trigger the MAC circuit 106 to control the RF circuit 102 to switch to the other channel (the second channel) for preamble detection after completion of receiving the PHY layer packet. Otherwise, if the baseband circuit 104 does not detect an SFD in a preset detection period, the baseband circuit 104 triggers the MAC circuit 106 to control the RF circuit 102 to switch to the other channel (the second channel) for preamble detection.

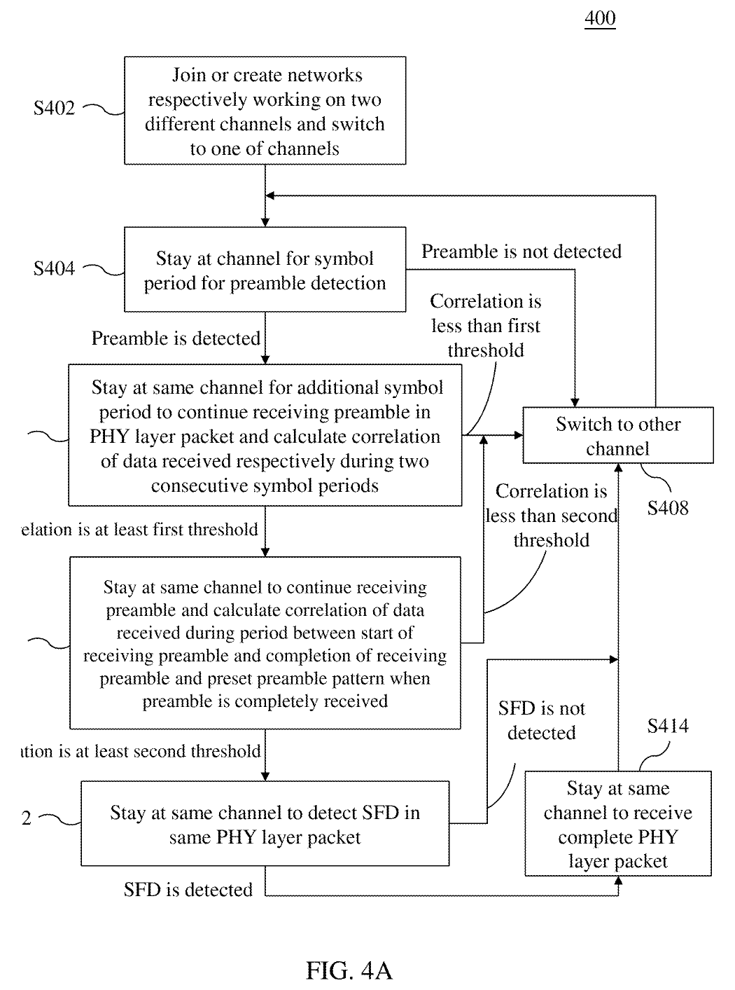

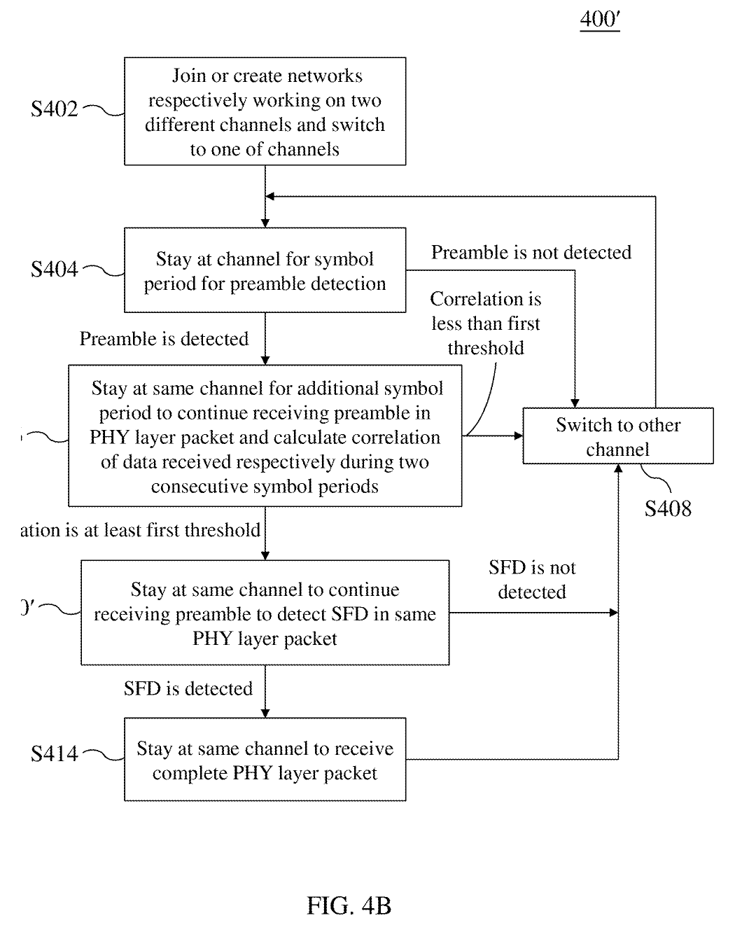

FIG. 4A a schematic flowchart of a method of controlling PHY layer packet reception in accordance with some embodiments of the present disclosure. The method 400 is applicable to a wireless communication device supporting the IEEE 802.15.4 Standards, such as the wireless communication device 100 in FIG. 1 and another wireless communication device with similar structure (i.e., having electrical function such as the RF circuit 102, the baseband circuit 104, and the MAC circuit 106).

The method 400 is performed by a wireless communication device and includes the following operations. In the beginning, Operation S402 is performed to join or create networks respectively working on two different channels (e.g., a ZigBee network and a Thread network) and switch to one of the channels (a first channel or a second channel). After completion of switching to one of the channels, Operation S404 is performed to stay at this channel (the first channel or the second channel) for a symbol period (a first symbol period) for preamble detection (which does not need to be aligned with a boundary of a preamble symbol). If the preamble is detected in the symbol period, Operation S406 is performed to stay at the same channel (the first channel) for an additional symbol period (a second symbol period) to continue receiving the preamble in the PHY layer packet and to calculate the correlation of the data received respectively during these two consecutive symbol periods (i.e., the first symbol period and the second symbol period), so as to determine whether to keep staying at the first channel to continue receiving the PHY layer packet according to the correlation. Otherwise, If the preamble is not detected in the symbol period, Operation S408 is performed to switch to the other channel (the second channel or the first channel), and Operation S404 is performed to stay at this channel (the second channel or the first channel) for a symbol period (the first symbol period) for preamble detection.

After Operation S406, if the correlation of the data received respectively during two consecutive symbol periods is at least a first threshold, Operation S410 is performed to stay at the same channel to continue receiving the preamble, and to calculate the correlation of the data received during the period between start of receiving the preamble and completion of receiving the preamble and a preset preamble pattern when the preamble is completely received. Otherwise, if the correlation of the data received respectively during two consecutive symbol periods is less than the first threshold, Operation S408 is performed.

After Operation S410, if the correlation of the data received during the period between the start of receiving the preamble and the completion of receiving the preamble and the preset preamble pattern is at least a second threshold, Operation S412 is performed to stay at the same channel (the first channel or the second channel) to detect the SFD in the same PHY layer packet. Otherwise, if the correlation of the data received during the period between the start of receiving the preamble and the completion of receiving the preamble and the preset preamble pattern is less than the second threshold, Operation S408 is performed.

If the SFD is detected in a preset detection period, the process proceeds from Operation S412 to Operation S414 to stay at the same channel (the first channel or the second channel) and receive the PHY layer packet completely, and Operation S408 may be performed after completion of receiving the PHY layer packet. Otherwise, if the SFD is not detected in the preset detection period, the process proceeds from Operation S412 to Operation S408.

FIG. 4B is a schematic flowchart of a method 400′ of controlling PHY layer packet reception in accordance with other some embodiments of the present disclosure. Similarly, the method 400′ is applicable to a wireless communication device supporting the IEEE 802.15.4 Standards, such as the wireless communication device 100 in FIG. 1 and another wireless communication device with similar structure.

The difference between the methods 400′ and 400 is as follows. In the method 400′, if the correlation of the data received respectively during two consecutive symbol periods is at least a first threshold, the process proceeds from Operation S406 to Operation S410′ to stay at the same channel (the first or second channel) to continue receiving the preamble and then detect the SFD in the same PHY layer packet. If the SFD is detected in a preset detection period, the process proceeds from Operation S410′ to Operation S414 to stay at the same channel (the first or second channel) and receive the PHY layer packet completely, and Operation S408 may be performed after completion of receiving the PHY layer packet. Otherwise, if the SFD is not detected in the preset detection period, the process proceeds from Operation S410′ to Operation S408. The other operations of the method 400′ refers to the description of FIG. 4A and is not repeated herein.

It is noted that the aforementioned mechanism for controlling reception of PHY layer packets is also applicable to a wireless local area network supporting another technical standard (for example, but not limited to, the IEEE 802.11 Standards and the IEEE 802.15.1 Standards) instead of being restricted to the wireless local area network that supports the IEEE 802.15.4 Standards.

It will be apparent to those skilled in the art that various modifications and variations can be made to the structure of the disclosure without departing from the scope or spirit of the disclosure cover modifications and variations of this disclosure provided they fall within the scope of the following claims.

What is claimed is:

1. A wireless communication device, comprising:
a media access control (MAC) circuit configured to join or create a first network that works on a first channel and a second network that works on a second channel at the same time;
a radio frequency (RF) circuit configured to switch to the first channel according to a control of the MAC circuit; and
a baseband circuit coupled to the MAC circuit and the RF circuit, the baseband circuit configured to stay on the first channel for a first symbol period to perform a preamble detection after the RF circuit completes switching to the first channel;
wherein in response to detecting a preamble of a physical (PHY) layer packet during the first symbol period, the baseband circuit further stays on the first channel for a second symbol period to continue receiving the preamble, and calculates a first correlation between data received respectively during the first symbol period and the second symbol period, and determines whether to stay on the first channel to continue receiving the PHY layer packet based on the first correlation.

2. The wireless communication device of claim 1, wherein in response to not receiving the preamble during the first symbol period, the baseband circuit triggers the MAC circuit to control the RF circuit to switch to the second channel for the preamble detection.

3. The wireless communication device of claim 1, wherein in response to the first correlation of the data received respectively during the first symbol period and the second symbol period being at least a first threshold, the baseband circuit notifies the MAC circuit to stay on the first channel to continue receiving the preamble and detect a start of frame delimiter (SFD) of the PHY layer packet.

4. The wireless communication device of claim 1, wherein in response to the first correlation of the data received respectively during the first symbol period and the second symbol period being less than a first threshold, the baseband circuit triggers the MAC circuit to control the RF circuit to switch to the second channel for the preamble detection.

5. The wireless communication device of claim 1, wherein:
in response to the first correlation of the data received respectively during the first symbol period and the second symbol period being at least a first threshold, the baseband circuit notifies the MAC circuit to stay on the first channel to continue receiving the preamble; and
in response to a second correlation of data received during a period between start of receiving the preamble and completion of receiving the preamble and a preset preamble pattern being at least a second threshold, the baseband circuit notifies the MAC circuit to stay on the first channel to detect an SFD of the PHY layer packet.

6. The wireless communication device of claim 5, wherein in response to the second correlation of the data received during the period between the start of receiving the preamble and the completion of receiving the preamble and the preset preamble pattern being less than the second threshold, the baseband circuit triggers the MAC circuit to control the RF circuit to switch to the second channel for the preamble detection.

7. The wireless communication device of claim 5, wherein in response to detecting the SFD during a preset detection period, the baseband circuit notifies the MAC circuit to stay on the first channel and receive the PHY layer packet completely.

8. The wireless communication device of claim 7, wherein the baseband circuit triggers the MAC circuit to control the RF circuit to switch to the second channel for the preamble detection after completion of receiving the PHY layer packet.

9. The wireless communication device of claim 5, wherein in response to not detecting the SFD during a preset detection period, the baseband circuit triggers the MAC circuit to control the RF circuit to switch to the second channel for the preamble detection.

10. The wireless communication device of claim 1, wherein the first network and the second network are IEEE 802.15.4-based networks.

11. The wireless communication device of claim 1, wherein the wireless communication device is a coordinator or a router.

12. A method of controlling physical layer packet reception performed by a wireless communication device, the method comprising:
joining or creating a first network that works on a first channel and a second network that works on a second channel, and switching to the first channel at the same time;
staying on the first channel for a first symbol period to perform a preamble detection; and
in response to detecting a preamble of a PHY layer packet during the first symbol period, staying on the first channel for a second symbol period to continue receiving the preamble, and calculating a first correlation between data received respectively during the first symbol period and the second symbol period, and determining whether to stay on the first channel to continue receiving the PHY layer packet based on the first correlation.

13. The method of claim 12, further comprising:
in response to not receiving the preamble during the first symbol period, switching to the second channel for the preamble detection.

14. The method of claim 12, further comprising:
in response to the first correlation of the data received respectively during the first symbol period and the second symbol period being at least a first threshold, staying on the first channel to continue receiving the preamble and detect an SFD of the PHY layer packet.

15. The method of claim 12, further comprising:
in response to the first correlation of the data received respectively during the first symbol period and the second symbol period being less than a first threshold, switching to the second channel for the preamble detection.

16. The method of claim 12, further comprising:
in response to the first correlation of the data received respectively during the first symbol period and the second symbol period being at least a first threshold, staying on the first channel to continue receiving the preamble; and
in response to a second correlation of data received during a period between start of receiving the preamble and completion of receiving the preamble and a preset preamble pattern being at least a second threshold, staying on the first channel to detect an SFD of the PHY layer packet.

17. The method of claim 16, further comprising:
in response to the second correlation of the data received during the period between the start of receiving the preamble and the completion of receiving the preamble and the preset preamble pattern being less than the second threshold, switching to the second channel for the preamble detection.

18. The method of claim 16, further comprising:
in response to detecting the SFD during a preset detection period, staying on the first channel and receiving the PHY layer packet completely.

19. The method of claim 18, further comprising:
switching to the second channel for the preamble detection after completion of receiving the PHY layer packet.

20. The method of claim 16, further comprising:
in response to not detecting the SFD during a preset detection period, switching to the second channel for the preamble detection.
